(19) United States
(12) Patent Application Publication
(10) Pub. No.: US 2011/0200130 A1
(43) Pub. Date: Aug. 18, 2011

(54) METHOD AND APPARATUS FOR TRANSMITTING/RECEIVING DATA IN MU-MIMO SYSTEM

(75) Inventors: Jeeyon CHOI, Daejeon (KR); Sok-Kyu LEE, Daejeon (KR)

(73) Assignee: Electronics and Telecommunications Research Institute, Daejeon (KR)

(21) Appl. No.: 13/025,048

(22) Filed: Feb. 10, 2011

(30) Foreign Application Priority Data
Feb. 11, 2010 (KR) 10-2010-0012791

(51) Int. Cl. H04L 27/28

(52) U.S. Cl. 375/260

(57) ABSTRACT

A method for transmitting, by a single transmitting station, data to a plurality of receiving stations includes: generating a plurality of data frames including the data and Ack order information; transmitting the plurality of data frames to the plurality of receiving stations; and sequentially receiving block Ack signals from the plurality of receiving stations according to the Ack order information.

### CROSS-REFERENCE(S) TO RELATED APPLICATIONS

The present application claims priority of Korean Patent Application No. 10-2010-0012791 filed on Feb. 11, 2010, which is incorporated herein by reference in its entirety.

### BACKGROUND OF THE INVENTION

1. Field of the Invention

Exemplary embodiments of the present invention relate to a method and apparatus for transmitting/receiving data; and, more particularly, to a method and apparatus for transmitting/receiving data in a Multi User-Multi Input Multi Output (MU-MIMO) system.

2. Description of Related Art

An 802.11 wireless LAN basically supports an access point (AP) serving as an association point of a distributed system (DS), and a basic service set (BSS) including a plurality of stations (STAs).

As the number of wireless LAN users has recently increased, there is an increasing demand for increasing data throughput provided by a single BSS. An existing wireless LAN does not allow a single terminal to communicate with two or more terminals at the same time. To provide the throughput of gigabytes or more, extensive research has been conducted to make it possible for a single terminal to communicate with a plurality of terminals at the same time. Representative examples are a MU-MIMO technique and a multi frequency channel technique. If using these techniques, a single terminal operates as if it exchanges data with a plurality of terminals through independent communication paths at the same time. Accordingly, a single terminal can transmit data to a plurality of terminals at the same time, leading to a significant increase in the throughput of a BSS.

Meanwhile, it is general that data is transmitted using a plurality of independent communication paths at the same time, and a control signal (a reception acknowledgement (Ack) signal), such as Ack or block Ack, is transmitted not through independent communication paths but through a communication path shared by all terminals. This is done for preventing collision due to the simultaneous transmission of data by receiving a control signal transmitted from other terminal. Hereinafter, the plurality of independent communication paths will be referred to as multi channels, and the communication path shared by all terminals will be referred to as a primary channel.

As described above, if a single terminal (e.g., an AP) transmits data to a plurality of terminals (e.g., STAs) through multi channels at the same time, the STAs having received the data transmit an Ack or block Ack signal through a primary channel. At this time, the above-mentioned data collision may occur if the plurality of STAs having received the data transmit the Ack or block Ack signal through the same primary channel, without taking into consideration the data reception of other STAs.

### SUMMARY OF THE INVENTION

An embodiment of the present invention is directed to prevent data collision by setting an order in which receiving stations having received data transmit reception Ack signals to a transmitting station, when one transmitting station transmits data to the plurality of receiving stations.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a method for transmitting, by a single transmitting station, data to a plurality of receiving stations includes: generating a plurality of data frames including the data and Ack order information; transmitting the plurality of data frames to the plurality of receiving stations; and sequentially receiving block Ack signals from the plurality of receiving stations according to the Ack order information.

In accordance with another embodiment of the present invention, a method for receiving, by a plurality of receiving stations, data transmitted from a single transmitting station includes: receiving data frames including the data and Ack order information; acquiring the Ack order information from the data frames; and sequentially transmitting block Ack signals to the transmitting station according to the Ack order information.

In accordance with another embodiment of the present invention, a method for transmitting, by a single transmitting station, data to a plurality of receiving stations includes: generating, by the transmitting station, a plurality of data frames including the data and Ack order information; transmitting, by the transmitting station, the plurality of data frames to the plurality of receiving stations; receiving, by the plurality of receiving stations, the data frames; acquiring, by the plurality of receiving stations, the Ack order information from the data frames; and sequentially transmitting, by the plurality of receiving stations, block Ack signals to the transmitting station according to the Ack order information.

### BRIEF DESCRIPTION OF THE DRAWINGS

FIG. 1 is a view illustrating an Aggregated-MAC Protocol Data Unit (A-MPDU) structure of IEEE. 802.11 and a subframe structure thereof.

FIG. 2 is a view illustrating conventional A-MPDU transmission and A-MPDU reception Ack processes.

FIG. 3 is a view explaining a problem occurring when a receiving station transmits a reception Ack signal after a single transmitting station transmits data to a plurality of receiving stations.

FIG. 4 is a view illustrating a subframe structure that is used in an exemplary embodiment of the present invention.

FIG. 5 is a view illustrating a method for transmitting/receiving data in accordance with an embodiment of the present invention.

FIG. 6 is a view illustrating a method for transmitting/receiving data in accordance with another embodiment of the present invention.

FIG. 7 is a view illustrating a method for transmitting/receiving data in accordance with another embodiment of the present invention.

FIG. 8 is a flowchart illustrating a method for transmitting data in accordance with an embodiment of the present invention.

FIG. 9 is a flowchart illustrating a method for receiving data in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

In a wired/wireless communication network, data is processed in predetermined units. Such data unit is different in each communication protocol. For example, in IEEE 802.11, the international standard for wireless LAN, data unit in a Media Access Control (MAC) is called a MAC Protocol Data Unit (MPDU). To increase the efficiency of a MAC layer with respect to a data rate of a physical layer, IEEE 802.11 proposes a method that aggregates a plurality of MPDUs and processes them by a single data unit in the physical layer. The aggregated MPDUs are referred to as Aggregated-MPDU (A-MPDU).

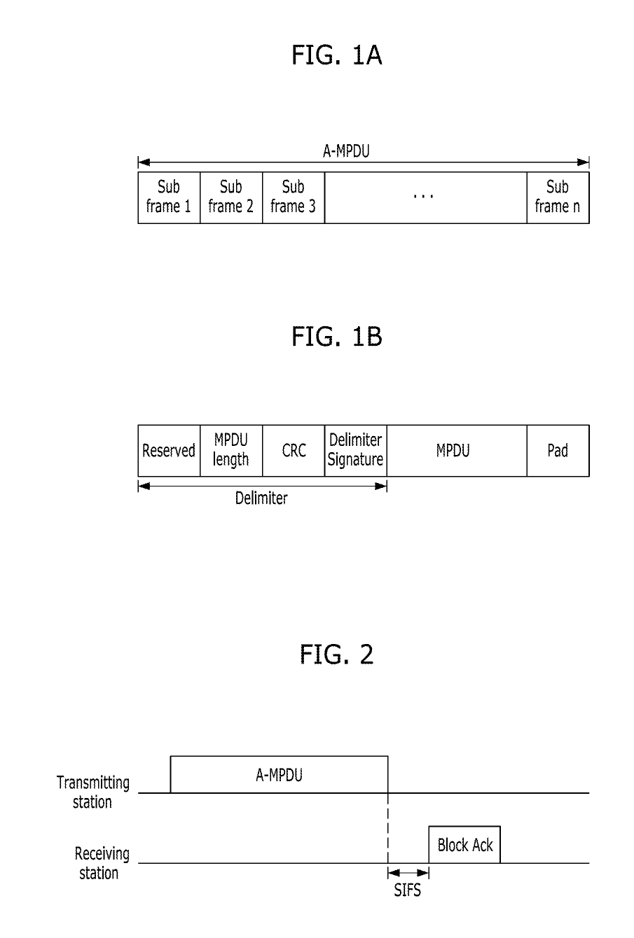

FIG. 1 is a view illustrating an A-MPDU structure of IEEE. 802.11 and a subframe structure thereof. As illustrated in FIG. 1A, the A-MPDU includes a plurality of subframes. FIG. 1B illustrates the subframe structure of the A-MPDU.

As illustrated in FIG. 1B, the subframe of the A-MPDU includes a delimiter field, an MPDU field, and a pad field. The delimiter field serves to distinguish a corresponding MPDU and includes a reserved field, an MPDU length field, a CRC field, and a delimiter signature field. The MPDU length field contains information on the length of the MPDU included in the corresponding subframe, and the CRC field is used to guarantee the integrity of the delimiter. In addition, the delimiter signature field is used to specify the corresponding delimiter.

Referring again to FIG. 1B, the MPDU contains data to be transmitted. Meanwhile, if necessary, a 0-3 byte pad field may be inserted so that an interval between start points of the delimiters of the respective subframes becomes an integer multiple of 32 bits.

According to the conventional art, when a receiving station receives the A-MPDU of FIG. 1A, which is transmitted by a transmitting station, the receiving station transmits a reception Ack signal to the transmitting station after the passage of a certain time. FIG. 2 is a view illustrating conventional A-MPDU transmission and A-MPDU reception Ack processes. As illustrated in FIG. 2, when the transmitting station transmits the A-MPDU, the receiving station transmits the reception Ack signal to the transmitting station after the passage of a certain time, that is, the receiving station transmits a block Ack signal to the transmitting station after the passage of a Short Inter Frame Space (SIFS).

The data transmission and reception process and the data reception Ack process illustrated in FIG. 2 can be applied to a conventional 1:1 communication without problems. However, in a case in which a single station is intended to transmit data to a plurality of stations through a plurality of independent communication paths (i.e., multi channels) at the same time, the application of the processes illustrated in FIG. 2 may be problematic. Hereinafter, for convenience's sake, the A-MPDU will be referred to as a data frame for convenience.

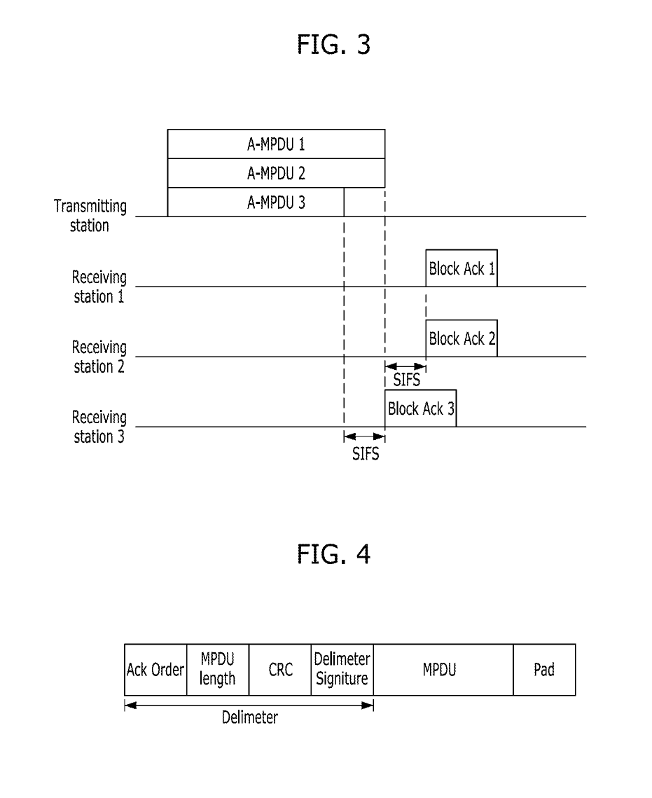

FIG. 3 is a view explaining a problem occurring when a receiving station transmits a reception Ack signal after a single transmitting station transmits data to a plurality of receiving stations. As illustrated in FIG. 3, when the timings at which two or more receiving stations transmit the reception Ack signals are identical (the first receiving station-the second receiving station) or are overlapped (the second receiving station-the second receiving station), the transmitting station may cause an error during the reception of the reception Ack signals or may not receive the reception Ack signals. This problem occurs when the receiving stations having received data frames having the same or different lengths transmit the reception Ack signals, without taking into consideration the timings at which other receiving stations transmit the reception Ack signals.

To solve such problems, the present invention provides a method for transmitting/receiving data, which is capable of preventing the collision of reception Ack signals by setting an order in which a plurality of receiving stations having received data frames transmit reception Ack signals.

Hereinafter, a method for transmitting/receiving data in accordance with exemplary embodiments of the present invention will be described in detail.

To set the reception Ack signal transmitting order of the receiving stations, a subframe structure illustrated in FIG. 4 is used in the exemplary embodiments of the present invention. The subframe illustrated in FIG. 4 includes a reception Ack order field, i.e., an Ack order field, instead of the reserved field of the conventional subframe illustrated in FIG. 1.

### Embodiment 1

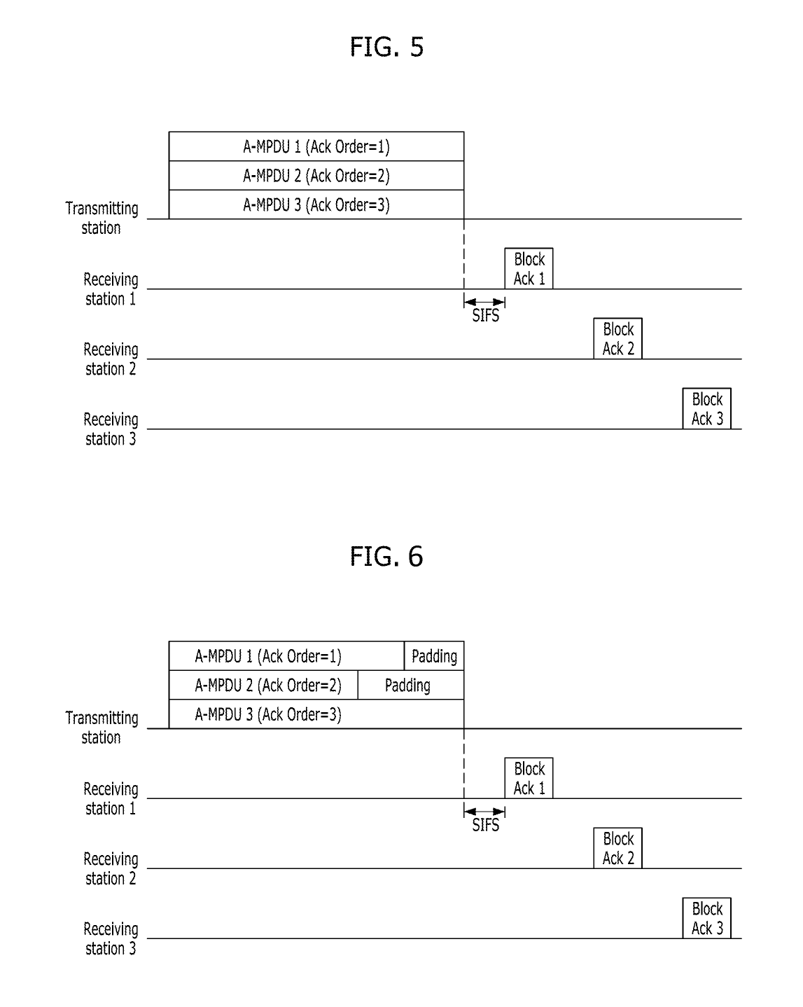

FIG. 5 is a view illustrating a method for transmitting/receiving data in accordance with an embodiment of the present invention.

Referring to FIG. 5, a transmitting station transmits data frames, i.e., first to third A-MPDUs, to the first to third receiving stations through multi channels at the same time. At this time, the order to transmit the block Ack signals to the transmitting station after reception of the data frames is set as follows: the first receiving station, the second receiving station, and the third receiving station (which is represented by Ack order).

Therefore, the transmitting station generates a plurality of data frames including data to be transmitted to the respective receiving stations and Ack order information, or receives them from the outside. In this embodiment, the Ack order information included in the data frame contains information representing a relative order in which a plurality of receiving stations are to transmit the block Ack signals. For example, the Ack order information of the second A-MPDU may contain information of “Ack Order=2”. The second receiving station having received the data frame containing this Ack order information can know that it should transmit the block Ack signal for the second time after another station.

As described above, the data frame from the transmitting station is transmitted through a plurality of independent paths, i.e., multi channels, whereas the block Ack signals from the receiving stations are transmitted through a communication path shared by all stations, i.e., a primary channel. Therefore, in this embodiment, the respective receiving stations check its own Ack order, checks whether another receiving station transmits a block Ack signal, and transmits a block Ack signal in its own turn. For example, in the case of FIG. 5, the first receiving station receives the data frame from the transmitting station, and transmits the first block Ack signal for the first time after the passage of a certain time SIFS. Then, after the passage of a certain time again, the second receiving station transmits the second block Ack signal in its own turn.

In addition, in another embodiment of the present invention, the receiving stations may calculate (SIFS time+block Ack transmission time) according to their Ack order and transmit their block Ack signals, without confirming the block Ack transmission of other receiving stations. For example, in the case of FIG. 5, the second receiving station may confirm that its own Ack order is “2” and transmit the block Ack signal after the passage of (SIFS+transmission time of the first block Ack signal+SIFS).

### Embodiment 2

FIG. 6 is a view illustrating a method for transmitting/receiving data in accordance with another embodiment of the present invention.

In the embodiment of FIG. 6, data frames transmitted to the respective receiving stations have different lengths, as opposed to the embodiment of FIG. 5. In this case, the respective receiving stations need to complete the reception of the data frames at the same timing so that they transmit their block Ack signals in the Ack order set by the transmitting station.

Therefore, in the embodiment of FIG. 6, padding bits are inserted so that data frames other than the longest data frame have the same length as the longest data frame. The padding bits may be inserted into either or both of a MAC layer and a PHY layer.

As illustrated in FIG. 6, the lengths of the respective data frames become equal to one another by the insertion of the padding bits. After the data frames into which the padding bits are inserted are transmitted to the receiving stations, the respective receiving stations transmit their block Ack signals to the transmitting station in the relative order information contained in the Ack order information, as in the case of the embodiment 1.

### Embodiment 3

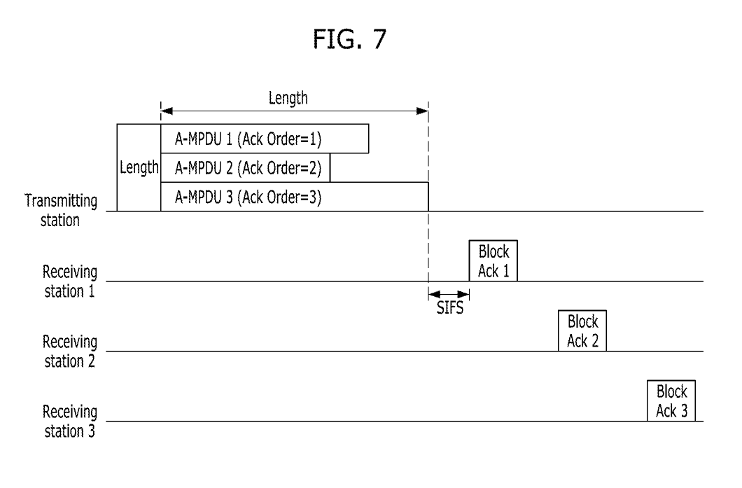

FIG. 7 is a view illustrating a method for transmitting/receiving data in accordance with another embodiment of the present invention.

Like in the embodiment of FIG. 6, data frames in the embodiment of FIG. 7 have different lengths. However, padding bits are not inserted into the data frames, as opposed to the embodiment of FIG. 6. Instead, a transmitting station transmits data frames containing Ack order information that contains information on time for respective receiving stations to transmit block Ack signals. The information on time for the respective receiving stations to transmit the block Ack signals is divided into relative time information and absolute time information.

For example, the Ack order information may contain information (Ack order=1, 2, 3) representing a relative order in which the receiving stations are to transmit their block Ack signals, which has been described above in the embodiments 1 and 2, and information on relative transmission time (e.g., 2 seconds). The second receiving station having received the data frame containing the Ack order information checks its own Ack order and relative transmission time information, and transmits a block Ack signal two seconds after the first receiving station transmits a block Ack signal. Therefore, the relative transmission time information represents the relative order to transmit the block Ack signals, which has been described above in the embodiment 1.

Meanwhile, in another embodiment, the Ack order information may contain absolute time information for the respective receiving stations to transmit their block Ack signals. In this case, the receiving stations transmit their block Ack signals at time specified in the Ack order information, regardless of whether other receiving stations transmit their block Ack signals or not.

In another embodiment, instead of the above-described relative or absolute time information, information on the longest data frame may be contained in the Ack order information. For example, in a case in which the third A-MPDU is the longest data frame as illustrated in FIG. 7, each data frame contains information on the length of the longest data frame, i.e., the third A-MPDU, or information on the time necessary to receive the third A-MPDU. The receiving stations having received the data frames calculates or directly acquires the time necessary to receive the longest data frame using the Ack order information. Thus, the receiving stations can check the time for the first receiving station to transmit the block Ack signal and then can transmit their block Ack signals according to the method of the embodiment 1.

The information on the longest data frame may be contained in the data frame transmitted by the transmitting station, or may be transmitted to the receiving stations as separate data. In a case in which the information on the longest data frame is transmitted as separate data, it may be transmitted through multi channels or a primary channel.

The information contained in the Ack order information described above with reference to FIG. 3, i.e., the relative or absolute time information or the information on the longest data frame, may be included in an overhead of a MAC layer, e.g., a delimiter of a MAC header or an A-MPDU subframe, or may be included in an overhead of a PHY layer, e.g., a SIG field or a service field.

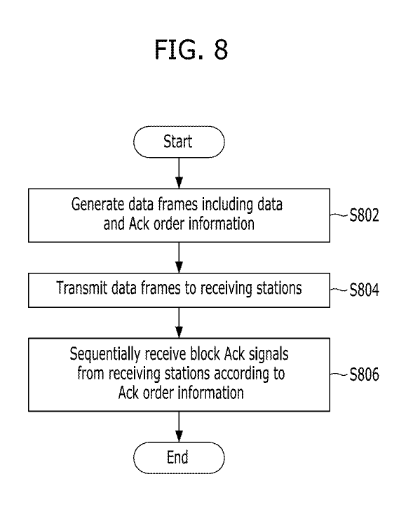

FIG. 8 is a flowchart illustrating a method for transmitting data in accordance with an embodiment of the present invention. In step S802, a plurality of data frames to be transmitted to a plurality of receiving stations are generated. Each of the data frames contains data to be transmitted and Ack order information. In addition, each of the data frames may include a padding bit to make it have the same length as the longest data frame. In another embodiment, the plurality of data frames may be inputted from other devices.

In step S804, the plurality of data frames are transmitted to the plurality of receiving stations. In step S806, if the respective receiving stations complete the reception of the data frames, block Ack signals are sequentially received from the plurality of receiving stations according to the Ack order information contained in the respective data frames. The Ack order information may contain information representing a relative order for the plurality of receiving stations to transmit the block Ack signal, information on the longest data frames among the plurality of data frames, or information representing time for the plurality of receiving stations to transmit their block Ack signals.

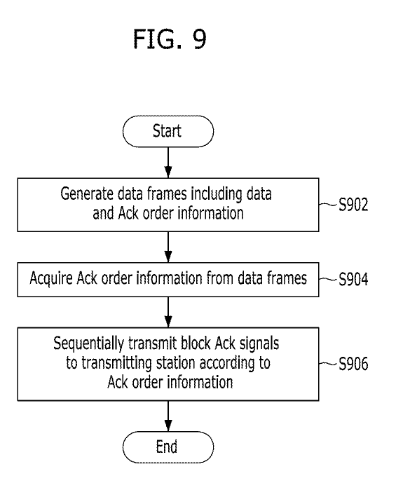

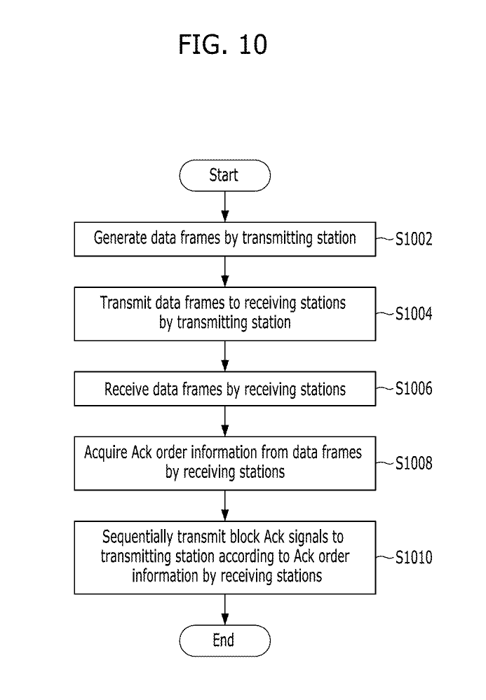

FIG. 9 is a flowchart illustrating a method for receiving data in accordance with an embodiment of the present invention.

In step S902, data frames containing data and Ack order information, transmitted by a transmitting station, are received. In step S904, the Ack order information is acquired from the received data frames. Each of the data frames may include a padding bit to make it have the same length as the longest data frame. In addition, the Ack order information may contain information representing a relative order for the plurality of receiving stations to transmit the block Ack signal, information on the longest data frames among the plurality of data frames, or information representing time for the plurality of receiving stations to transmit their block Ack signals.

In step S906, block Ack signals are sequentially transmitted to the transmitting station according to the acquired Ack order information. The process of sequentially transmitting the block Ack signals is substantially identical to that described above with reference to FIGS. 5 to 7 and the embodiments.

FIG. 10 is a flowchart illustrating a method for transmitting data in accordance with another embodiment of the present invention.

In step S1002, a transmitting station generates a plurality of data frames to be transmitted to a plurality of receiving stations. Each of the data frames contains data to be transmitted and Ack order information. In addition, each of the data frames may include a padding bit to make it have the same length as the longest data frame. In another embodiment, the plurality of data frames may be inputted from other devices. In step S1004, the transmitting station transmits the plurality of data frames to the plurality of receiving stations. In step S1006, the plurality of receiving stations receive the data frames transmitted from the transmitting station.

In step S1008, the plurality of receiving stations acquire the Ack order information from the received data frames. Each of the data frames may include a padding bit to make it have the same length as the longest data frame. In addition, the Ack order information may contain information representing a relative order for the plurality of receiving stations to transmit the block Ack signal, information on the longest data frames among the plurality of data frames, or information representing time for the plurality of receiving stations to transmit their block Ack signals.

In step S1010, the plurality of receiving stations sequentially transmit block Ack signals to the transmitting station according to the acquired Ack order information. The process of sequentially transmitting the block Ack signals is substantially identical to that described above with reference to FIGS. 5 to 7 and the embodiments.

In accordance with the exemplary embodiments of the present invention, when a single transmitting station transmits data to a plurality of receiving stations, data collision can be substantially prevented by setting an order in which the receiving stations having received data are to transmit their block Ack signals to the transmitting station.

While the present invention has been described with respect to the specific embodiments, it will be apparent to those skilled in the art that various changes and modifications may be made without departing from the spirit and scope of the invention as defined in the following claims.

What is claimed is:

1. A method for transmitting, by a single transmitting station, data to a plurality of receiving stations, the method comprising:
generating a plurality of data frames including the data and Ack order information;
transmitting the plurality of data frames to the plurality of receiving stations; and
sequentially receiving block Ack signals from the plurality of receiving stations according to the Ack order information.

2. The method of claim 1, wherein the Ack order information includes information representing a relative order for the plurality of receiving stations to transmit the block Ack signals.

3. The method of claim 2, wherein the Ack order information further includes information on the longest data frames among the plurality of data frames, and the receiving station transmitting the block Ack signal for the first time among the plurality of receiving stations transmits the block Ack signal after the reception of the longest data frame is completed.

4. The method of claim 1, wherein the Ack order information includes information on time for the plurality of receiving stations to transmit the block Ack signals.

5. The method of claim 1, wherein the plurality of data frames further include padding bits to make the data frames have the same length as the longest data frame.

6. A method for receiving, by a plurality of receiving stations, data transmitted from a single transmitting station, the method comprising:
receiving data frames including the data and Ack order information;
acquiring the Ack order information from the data frames; and
sequentially transmitting block Ack signals to the transmitting station according to the Ack order information.

7. The method of claim 6, wherein the Ack order information includes information representing a relative order for the plurality of receiving stations to transmit block Ack signals.

8. The method of claim 7, wherein the Ack order information further includes information on the longest data frame among the plurality of data frames transmitted by the transmitting station, and the receiving station transmitting the block Ack signal for the first time among the plurality of receiving stations transmits the block Ack signal after the reception of the longest data frame is completed.

9. The method of claim 6, wherein the Ack order information includes information on time for the plurality of receiving stations to transmit the block Ack signals.

10. The method of claim 6, wherein the plurality of data frames further include padding bits to make the data frames have the same length as the longest data frame.

11. A method for transmitting, by a single transmitting station, data to a plurality of receiving stations, the method comprising:
generating, by the transmitting station, a plurality of data frames including the data and Ack order information;
transmitting, by the transmitting station, the plurality of data frames to the plurality of receiving stations;
receiving, by the plurality of receiving stations, the data frames;
acquiring, by the plurality of receiving stations, the Ack order information from the data frames; and
sequentially transmitting, by the plurality of receiving stations, block Ack signals to the transmitting station according to the Ack order information.

12. The method of claim 11, wherein the Ack order information includes information representing a relative order for the plurality of receiving stations to transmit block Ack signals.

13. The method of claim 12, wherein the Ack order information further includes information on the longest data frame among the plurality of data frames transmitted by the transmitting station, and the receiving station transmitting the block Ack signal for the first time among the plurality of receiving stations transmits the block Ack signal after the reception of the longest data frame is completed.

14. The method of claim 11, wherein the Ack order information includes information on time for the plurality of receiving stations to transmit the block Ack signals.

15. The method of claim 11, wherein the plurality of data frames further include padding bits to make the data frames have the same length as the longest data frame.
